(19) United States
(12) Patent Application Publication
(10) Pub. No.: US 2026/0230436 A1
(43) Pub. Date: Aug. 6, 2026

(54) HANDLING TRANSMISSION OF PACKETS FROM VIRTUALIZED ENVIRONMENT HOSTED BY TSN ENTITY

(71) Applicant: Telefonaktiebolaget LM Ericsson (publ), Stockholm (SE)

(72) Inventors: Dhruvin PATEL, AACHEN (DE); Joachim SACHS, SOLLENTUNA (SE); János FARKAS, KECSKEMÉT (HU); János HARMATOS, Budapest (HU); Balázs VARGA, BUDAPEST (HU); Marilet DE ANDRADE JARDIM, KISTA (SE); György MIKLÓS, PILISBOROSJENÖ (HU)

(73) Assignee: Telefonaktiebolaget LM Ericsson (publ), Stockholm (SE)

(21) Appl. No.: 19/153,965

(22) PCT Filed: Feb. 15, 2023
(86) PCT No.: PCT/SE2023/050133

§ 371 Date: Aug. 6, 2025

(51) Int. Cl. H04L 47/28; G06F 9/455; H04L 47/62

(52) U.S. Cl. CPC H04L 47/28; G06F 9/45558; H04L 47/62; G06F 2009/45595

(57) ABSTRACT

Embodiments of the present disclosure provide a method (400) for enabling transmission of packets from at least one virtualized computing instance (12) within a virtualized environment (50) to a physical interface (55) on a computing device (60). The virtualized environment (50) is resident on the computing device (60) being operated as a Time-Sensitive Networking, TSN, entity for a TSN system (100). The TSN system (100) is integrated to a wireless communication network (80). The method (400) is performed within the virtualized environment (50) by the computing device (60). The method (400) comprises identifying (402) at least one network entity (10a) connected to the at least one virtualized computing instance (12) within the virtualized environment (50), to be used for routing of the packets from the at least one virtualized computing instance (12) to the physical interface (55). The method (400) comprises determining (404) a scheduling configuration indicating timing information and packet traffic controlling information for the at least one virtualized computing instance (12) for transmission of the packets and for the identified at least one network entity (10a) for routing of the packets. The method (400) comprises causing (406) transmission of the packets from the at least one virtualized computing instance (12) to the physical interface (55) through the at least one network entity (10a) in accordance with the determination.

Corresponding computing device, and computer program products are also disclosed.

### TECHNICAL FIELD

The present disclosure relates generally to the field of Time-Sensitive Networking, TSN, systems. More particularly, it relates to method, computing device, and computer program products for handling transmission of packets from a virtualised computing instance within a virtualized environment to a physical interface on a computing device, wherein the virtualized environment is resident on the computing device being operated as an entity of a TSN system.

### BACKGROUND

An automation industry is undergoing a digital transformation towards the “Fourth Industrial Revolution” (Industry 4.0), which involves smart manufacturing. The automation industry provides flexible connectivity infrastructure, which is a key enabler for manufacturing to interconnect machines, products, and all kinds of other devices in a flexible, secure, and consistent manner.

Communication technology enablers for the digital transformation of the automation industry are Time Sensitive Networking, TSN, system (TSN network) on a wireline side, and a Third Generation Partnership Project, 3GPP, Fifth Generation, 5G, network on a wireless side. The TSN system is based on the Institute of Electrical and Electronics Engineers, IEEE 802.1 and 802.3 standard. The TSN system provides deterministic services with time synchronization, guaranteed low latency transmissions and high reliability. The 5G network, an alternative to a wired connectivity solution supports communication with unprecedented reliability and very low latency, as well as massive Internet of Things, IOT, connectivity. Thus, the TSN system and the 5G network are considered as complementary technologies in providing the deterministic communication services, thereby paying the way towards future advanced manufacturing systems and other vertical areas. In addition, the TSN system and the 5G network are essential for network convergence that is a support of all kinds of communication services via a same network infrastructure. Therefore, the TSN system can be integrated to the 5G network for supporting the deterministic/time sensitive services over heterogeneous infrastructure and multiple application domains essential for the network convergence.

FIG. 1A discloses an example existing implementation a TSN system 100 integrated to a 5G network. As depicted in FIG. 1A, the TSN system 100 integrated to the 5G network comprises TSN bridge(s) 70, virtual TSN bridge(s) 80, TSN end station(s) 45, and a computing device 60. The TSN bridge 70 is a wired node of the TSN system 100. The virtual TSN bridge 80 is the 5G network or a node implemented by the 5G network. The TSN end station 45 can include any industrial device (for example, robots). The computing device 60 can be the TSN end station or a device coupled to the TSN end station. The computing device 60 can host application(s) 5 for performing one or more tasks such as, industrial motion control, robot control, or the like. The computing device 60 comprises a controller (for example, a hardware-based controller) to execute the application 5. In an example herein, the application may have deterministic service requirements that involve time synchronization, low latency, and high reliability. Further, TSN devices such as the TSN bridges 70, the virtual TSN bridge 80, the TSN end station 45, and the computing device 60 can have interfaces (physical or virtual interfaces). The interface of the TSN device (70/80/45/60) can enable the TSN device (70/80/45/60) to transmit packets/TSN stream to another TSN device (70/80/45/60). Each interface can comprise one or more ports (such as, ingress and egress ports).

As depicted in FIG. 1A, the TSN system 100 further comprises a Centralized Network Controller, CNC, 90 and a Centralized User Configuration, CUC 95, for configuring and controlling operations of the TSN device (70/80/45/60). In some examples, the CNC 90 can determine a configuration and scheduling plan for each port of each TSN device (70/80/45/60) to ensure deterministic, and reliable communication, while exchanging the packets of the applications between the TSN devices (70/80/45/60) over an Ethernet/TSN network. The CNC 90 can determine the configuration and scheduling plan for the ports of the TSN device (70/80/45/60) based on deterministic service requirements and network characteristics (such as topology, latency characteristics) associated with the TSN device (70/80/45/60). Upon determination, the CNC 90 can push the configuration and scheduling plan to the ports of the TSN device (70/80/45/60).

The configuration and scheduling plan determined for the port of the TSN device (70/80/45/60) indicates one or more of: a number of packets/frames to be transmitted from the port of the TSN device (70/80/45/60) and a gating scheme implemented for a transmission gate associated with the port of the TSN device to control transmission of the packets at the port of the TSN device (70/80/45/60). In some examples, the gating scheme can be an IEEE 802.1Qbv time-aware scheduling based gating scheme. Such a gating scheme applies a transmission gate at the port of the TSN device (70/80/45/60), which is associated with a queue belonging to a Quality of Service, QoS, class and selects only packets/frames for transmission only when the transmission gate is open. Thus, ensuring precise end-to-end, E2E, timeliness in the TSN system 100.

Specifically, in case of transmissions from the computing device 60, the controller of the computing device 60 transmits packets generated during execution of the application 5 to a physical interface 55 (Ethernet interface) on the computing device 60, which further transmits the packets to the suitable TSN device, for example, the TSN bridge 70. The packets from the controller has to be received at the physical interface 55 according to a time window configured by the CNC 90 of the TSN system 100. Due to design of hardware and software components of the controller and linking of each instance of the application to the physical interface 55, the packets from the controller can be forwarded towards other TSN devices/network devices (for example, the TSN bridge 70) in the time window configured by the CNC 90 of the TSN system 100. Thus, guaranteeing precise E2E timeliness with deterministic performance. However, precise E2E timeliness cannot be guaranteed, if the application is executed within a virtualized environment hosted by the computing device 60.

FIG. 1B discloses an example possible implementation of a TSN system 100 integrated to a 5G network, wherein a computing device 60 operating as a TSN entity for the TSN system 100 hosts a virtualized environment 50.

As depicted in FIG. 1B, the computing device 60 hosts the virtualized environment 50 for execution of a plurality of applications 5a-5n, each application comprises one or more instances. The computing device 60 further deploys at least one virtualized computing instance 12 (for example, a container) in the virtualized environment 50 for execution of the at least one application/instance of the at least one application 5a-5n. The at least one virtualized computing instance 12 is connected to the at least one network entity 10 (for example, a virtual switch). The at least one network entity 10 is used to route the packets (generated during execution of the at least one application 5a-5n) from the virtualized computing instance 12 to the physical interface 55 on the computing device 60. However, there is no guarantee that packets from the virtualized computing instance 12 may reach the physical interface 55 on the computing device 60 within the time window defined by the CNC 90 of the TSN system 100, due to the following causes:
the application/instance of the application is linked to the virtual interface (Ethernet port) of the virtualized computing instance 12 instead of the computing device 60 and there may be networking between the application and the physical interface 55 on the computing device 60. Thus, there may be no relationship between the application and the physical interface 55;
timing of networking is not deterministic due to shared resource paradigm of the virtualized environment and configuration of the resources may change over time;
networking details (for example, topology, latency characteristics, or the like) of the network entities 10 are hidden from the CNC 90, so that the virtual interfaces of the at least one virtualized computing instance 12 and/or the at least one network entity 10 cannot be configured by the CNC 90;
virtualized environment management is not aware of TSN traffic schedule, so entities/resources (12, and 10) in the virtualized environment 50 cannot be configured by the CNC 90 according to the TSN traffic schedule/TSN time schedule.

Thus, precise E2E timeliness cannot be guaranteed in case of executions of the applications in the virtualized environment hosted by the computing device 60, which further results in unstable or even failed operation of the applications.

### SUMMARY

If deterministic, and reliable communication with precise E2E timeliness is to be provided while execution of the applications in the virtualized environment, it is not enough to properly configure the TSN, and 5G-TSN entities, but characteristics related to the virtualized environment and an effect of virtualization have to be considered.

Consequently, there is a need for an improved method and arrangement for handling transmissions of packets from the virtualized environment to the physical interface on the computing device being operated as the TSN entity for the TSN system that alleviates at least some of the above-cited problems.

It is therefore an object of the present disclosure to provide a method, a computing device, and a computer program product for enabling transmission of packets from at least one virtualized computing instance within the virtualized environment to a physical interface on a computing device, to mitigate, alleviate, or eliminate all or at least some of the above-discussed drawbacks of presently known solutions.

This and other objects are achieved by means of a method, a computing device, and a computer program product as defined in the appended claims. The term exemplary is in the present context to be understood as serving as an instance, example or illustration.

According to a first aspect of the present disclosure, a method for enabling transmission of packets from at least one virtualized computing instance within a virtualized environment to a physical interface on a computing device is provided. The virtualized environment being resident on the computing device. The computing device is operated as an entity of a Time-Sensitive Networking, TSN, system. The TSN system is integrated to a wireless communication network. The method is performed within the virtualized environment by the computing device. The method comprises identifying at least one network entity connected to the at least one virtualized computing instance within the virtualized environment, to be used for routing of the packets from the at least one virtualized computing instance to the physical interface. The method comprises determining a scheduling configuration indicating timing information and packet traffic controlling information for the at least one virtualized computing instance for transmission of the packets and for the identified at least one network entity for routing of the packets. The method comprises causing transmission of the packets from the at least one virtualized computing instance to the physical interface through the at least one network entity in accordance with the determination.

In some embodiments, the step of determining the scheduling configuration for the at least one virtualized computing instance and the identified at least one network entity comprises determining the scheduling configuration for an egress port of the at least one virtualized computing instance. The method comprises determining the scheduling configuration for an ingress port and an egress port of the at least one network entity.

In some embodiments, the step of determining the scheduling configuration comprises obtaining, from the physical interface, a TSN time schedule configured by a Centralized Network Controller, CNC, of the TSN system for the physical interface, and a scheduling scheme identifying scheduling of applications for execution within the virtualized environment. The method comprises obtaining network port configurations of the egress port of the at least one virtualized computing instance and the ingress and egress ports of the at least one network entity. The method comprises obtaining network configurations and capabilities of at least one network entity. Based on the obtained TSN time schedule, the scheduling scheme, the network port configurations, and the network configurations and capabilities of the at least one network entity, the method comprises determining the scheduling configuration for the egress port of the at least one virtualized computing instance and for the ingress and egress ports of the at least one network entity.

In some embodiments, the TSN time schedule indicates one or more of: a gating scheme being implemented on at least one port of the physical interface and a time interval configured for the at least one port of the physical interface for reception of the packets.

In some embodiments, the scheduling scheme indicates one or more of: a time interval defined for execution of at least one application within the virtualized environment, the at least one virtualized computing instance selected for execution of the at least one application within the virtualized environment to generate the packets and scheduling of one or more application instances of the at least one application on other virtualized computing instances.

In some embodiments, the network configurations and capabilities of the at least one network entity indicates one or more of: a topology of the at least one network entity, and latency characteristics of the plurality of entities.

In some embodiments, the step of determining the scheduling configuration for the egress port of the at least one virtualized computing instance comprises identifying a number of packets to be transmitted at the egress port of the at least one virtualized computing instance. The method comprises determining a time interval for transmission of the identified number of packets from the egress port of the at least one virtualized computing instance to the ingress port of the at least one network entity. The method comprises selecting, from pre-defined gating schemes, a first gating scheme to be implemented on the egress port of the at least one virtualized computing instance for controlling transmission of the identified number of packets at the egress port of the at least one virtualized computing instance in accordance with the determined time interval.

In some embodiments, determining the time interval for transmission of the identified number of packets from the egress port of the at least one virtualized computing instance is based on one or more of: the TSN time schedule configured by the CNC for the physical interface on the computing device and the scheduling scheme identifying scheduling of applications for execution within the virtualized environment.

In some embodiments, the step of determining the scheduling configuration for the ingress port of the at least one network entity comprises identifying a number of packets to be stored in a buffer at the ingress port of the at least one network entity. The method comprises determining a time interval for release of the packets from the buffer at the ingress port to the egress port of the at least one network entity according to at least one pre-defined packet releasing scheme. The method comprises selecting, from the pre-defined gating schemes, a second gating scheme to be implemented on the ingress port of the at least one network entity for controlling storing and transmission of the packets at the ingress port of the at least one network entity in accordance with the determined time interval.

In some embodiments, determining the time interval for release of the packets at the ingress port of the at least one network entity is based on one or more of: the TSN time schedule configured by the CNC for the physical interface on the computing device, the scheduling scheme identifying scheduling of applications for execution within the virtualized environment and the network configurations and capabilities of the at least one network entity.

In some embodiments, the step of determining the scheduling configuration for the egress port of the at least one network entity comprises determining a time interval for transmission of the packets from the egress port of the at least one network entity to the physical interface on the computing device. The method comprises selecting, from the pre-defined gating schemes, the first gating scheme to be implemented on the egress port of the at least one network entity for controlling transmission of the packets at the egress port of the at least one network entity in accordance with the determined time interval.

In some embodiments, determining the time interval for transmission of the packets from the egress port to the physical interface is based on the TSN time schedule configured by the CNC for the physical interface on the computing device.

In some embodiments, the step of identifying the at least one network entity connected to the at least one virtualized computing instance comprises: obtaining information related to a networking path of the virtualized environment and network configurations and capabilities of a plurality of network entities within the virtualized environment. Based on the obtained information related to the networking path and the network configurations and capabilities of the plurality of network entities, the method comprises identifying the at least one network entity of the plurality of network entities connected to the at least one virtualized computing instance.

In some embodiments, when no network entity of the plurality of network entities is identified in the virtualized environment, the method further comprises determining, based on the obtained information related to the networking path and the network configurations and capabilities of the plurality of entities, that the at least one network entity is not connected to the at least one virtualized computing instance, Upon the determination, the method comprises creating the at least one network entity with the ingress and egress ports for the at least one virtualized computing instance. The method comprises connecting the at least one network entity to the at least one virtualized computing instance.

According to a second aspect of the present disclosure, a computing device for enabling transmission of packets from at least one virtualized computing instance within a virtualized environment to a physical interface on the computing device is provided. The virtualized environment being resident on the computing device. The computing device is operated as an entity of a Time-Sensitive Networking, TSN, system. The TSN system is integrated to a wireless communication network. The computing device is adapted for identifying at least one network entity connected to the at least one virtualized computing instance within the virtualized environment, to be used for routing of the packets from the at least one virtualized computing instance to the physical interface. The computing device is adapted for determining a scheduling configuration indicating timing information and packet traffic controlling information for the at least one virtualized computing instance for transmission of the packets and for the identified at least one network entity for routing of the packets. The computing device is adapted for causing transmission of the packets from the at least one virtualized computing instance to the physical interface through the at least one network entity in accordance with the determination.

According to a third aspect of the present disclosure, there is provided a computer program product comprising a non-transitory computer readable medium, having thereon a computer program comprising program instructions. The computer program is loadable into a data processing unit and configured to cause execution of the method according to the first aspect when the computer program is run by the data processing unit.

In some embodiments, any of the above aspects may additionally have features identical with or corresponding to any of the various features as explained above for any of the other aspects.

An advantage of some embodiments is that alternative and/or improved approaches are provided for efficient handling of internal data traffic forwarding in the virtualized environment that is handling transmission of the packets from the virtualized computing instance in the virtualized environment to the physical interface on the computing device/TSN entity.

An advantage of some embodiments is that the scheduling configuration is determined for the at least one virtualized computing instance for transmission of the packets and for the at least one network entity connected to the at least one virtualized computing instance for routing of the packets. The scheduling configuration is determined based on one or more of: the TSN time schedule configured by the CNC for the physical interface, the scheduling scheme, the network port configurations of ports of the at least one virtualized computing instance and the at least on network entity, and the network configurations and capabilities of the at least one network entity. Thus, the scheduling configuration may be determined by considering TSN configurations, characteristics of components in the virtualized environment and an effect of virtualization.

An advantage of some embodiment is due to the scheduling configuration, traffic of packets at the at least one virtualized computing instance and the at least one network entity may be controlled in accordance with the TSN time schedule configured for the physical interface.

An advantage of some embodiments is that the transmission of the packets from the at least one virtualized computing instance to the physical interface through the at least one network entity in accordance with the scheduled configuration ensures reception of the packets at the physical interface within the time interval configured by the CNC for the physical interface. As a result, CNC configured TSN operations may not fail in an end-to-end, E2E, manner, which further guarantees precise E2E timeliness in the TSN system.

Other advantages may be readily apparent to one having skill in the art. Certain embodiments may have none, some, or all of the recited advantages.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1A discloses an example existing implementation of a Time-Sensitive Networking, TSN, system integrated to a wireless communication network;

FIG. 1B discloses an example possible implementation of a TSN system integrated to a wireless communication network, wherein a computing device operating as a TSN entity hosts a virtualized environment;

FIG. 2A discloses a TSN system integrated to a wireless communication network according to some examples;

FIG. 2B discloses a TSN system integrated to a wireless communication network, wherein a computing device hosting a virtualized environment handles transmission of packets from the virtualized environment according to some examples;

FIG. 3 discloses a computing device for handling transmission of packets from the virtualized environment according to some examples;

FIG. 4A is a flowchart illustrating example method steps according to some examples;

FIG. 4B is a flowchart illustrating example method steps according to some examples;

FIG. 5 is a schematic block diagram illustrating an example apparatus according to some examples; and

FIG. 6 discloses a computing environment according to some examples.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the examples set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

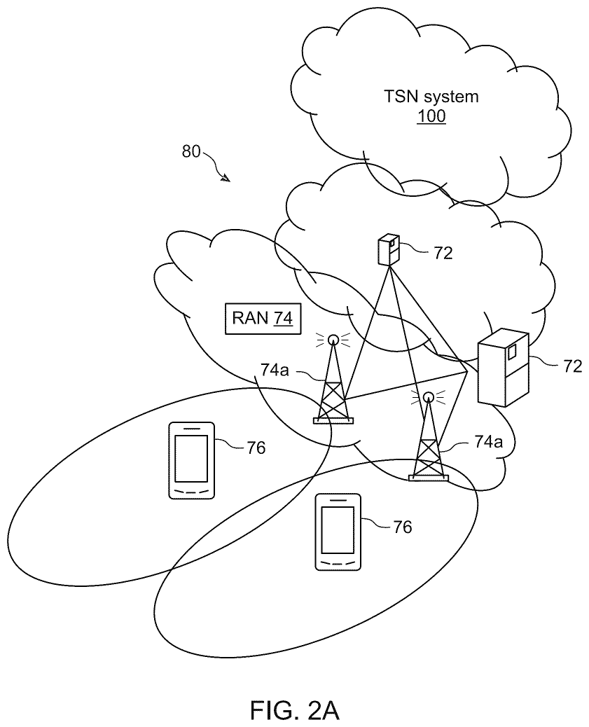

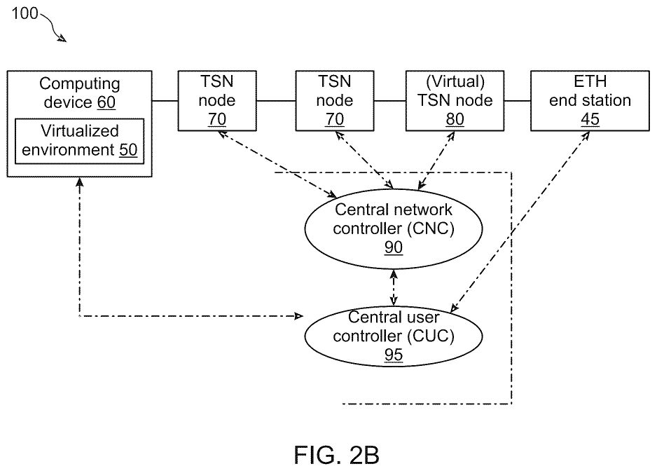

FIG. 2A discloses an example Time-Sensitive Networking, TSN, system 100 integrated to a wireless communication network 80. The TSN system 100 (also be referred to as TSN network) referred herein may be based on the Institute of Electrical and Electronics Engineers, IEEE 802.3 Ethernet standard. The TSN system 100 is integrated to the wireless communication network 80 to provide converged communication on a same network infrastructure for a wide range of applications that have deterministic service requirements (also be referred to as time sensitive requirements, futuristic service requirements, or the like). The deterministic service requirements may refer to provide communication service with guaranteed time synchronization/precise end-to-end, E2E, timeliness, high reliability, and low latency.

The wireless communication network 80 (also be referred to wireless communication system, cellular communication network/system, or the like) may be a wireless network, for example, a Fifth Generation, 5GS, network, a Long Term Evolution, LTE, network, an Evolved Universal Terrestrial Radio Access Network, E-UTRAN, a Wideband Code Division Multiple Access, WCDMA, network, a Global System for Mobile communications, GSM, network, a Worldwide Interoperability for Microwave Access, WiMAX, or any other future generation network.

The wireless communication network 80 may comprise a Radio Access Network, RAN, 74 and a core network, CN 72. The wireless communication network 80 may use a number of different Radio Access Technologies, RATs, such as LTE, LTE-Advanced, 5G, WCDMA, GSM/Enhanced Data rate for GSM Evolution, EDGE, WiMAX, Ultra Mobile Broadband, WMB, or the like.

The RAN 74 may comprise one or more network nodes 74a, each providing radio coverage over one or more geographical areas, such as cells supporting the one or more RATs. In some examples, the network node 74a may be a radio access node such as a radio network controller, an access point such as a Wireless Local Area Network, WLAN, access point or an Access Point Station, AP STA, an access controller, a base station, a base transceiver station, an Access Point base station, a base station router, a transmission arrangement of a radio base station, a standalone access point, or any other unit of the RAN capable of serving one or more User Equipments, UEs 76 in the cell/service area. Examples of the base station may include, a gNodeB, gNB, an evolved Node B, eNB, and so on.

The CN 72 may comprise a core network node. The core network node may be configured to communicate with the network node 74a via an interface, for example, an S1 interface. Example of the core network node may include User Plane Function, UPF.

In the wireless communication network 80, the one or more UEs 76 may communicate with the CN 72 via the network nodes 74a of the RAN 74. Examples of the UE 76 may include, but are not limited to, a wireless device, a mobile station, a non-access point, non-AP, station, STA, a wireless terminal, or the like. It should be understood by those skilled in the art that “wireless device” is a non-limiting term, which means any terminal, a wireless communication terminal, a User Equipment, a Mobile Type Communication, MTC, device, a Device to Device, D2D, terminal, or a node for example, a smart phone, a laptop, a mobile phone, a sensor, a relay, a mobile tablet, or even a base station communicating within the cell.

The UE 76 (also be referred to as first end station) may be connected to one or more TSN entities, for example, TSN end stations (referred to as second end station). The second end station may include, but are not limited to, robots, Automated Guided Vehicles, AGVs, with omni-wheels, excavators, or any other robotic devices.

With the integration of the TSN system 100, the wireless communication network 80 may operate as a TSN virtual bridge (also be referred to as TSN virtual node, virtual wireless bridge, or the like).

FIG. 2B discloses an example TSN system 100 integrated to the wireless communication network 80, wherein a computing device 60 being operated as a TSN entity hosts a virtualized environment 50.

As depicted in FIG. 2B, the TSN system 100 being integrated to the wireless communication network may comprise TSN bridges 70, a virtual TSN bridge 80, a TSN end station 45, and the computing device 60. In some examples, the TSN bridges 70, the virtual TSN bridge 80, the TSN end station 45, and the computing device 60 may be configured in a static configuration setup or a centralized network configuration setup. In the static configuration setup, the TSN bridges 70, the virtual TSN bridge 80, the TSN end station 45, and the computing device 60 may be configured during network setup. In the centralized network configuration setup, a Centralized Network Controller, CNC, 90 (also be referred to as centralized network configuration, TSN controller, or the like) may configure the TSN bridges 70, the virtual TSN bridge 80, the TSN end station 45, and the computing device 60 for TSN streams to be exchanged between each other. The CNC 90 may be adapted for configuring network resource reservations for the TSN bridges 70, the virtual TSN bridge 80, and the computing device 60. The CNC 90 may also be adapted for coordinating any changes to the configured network resource reservations with any new reservations. The network resource reservations may be made or requested by the TSN end station 45 and/or the computing device 60. In the fully centralized network configuration setup where both network and user configuration are centralized, the CNC 90 may receive requirements of data flows from a Centralized User Controller, CUC, 95 (also be referred to as centralized user configuration) and then compute a route, and a time schedule for end-to-end, E2E, transmission for each TSN stream. The CNC 90 may also configure the TSN bridges 70, the virtual TSN bridge 80, and the computing device 60 in accordance with the computed route and time schedule.

The TSN bridges 70 (also be referred to as TSN node, TSN wired bridge) may be wired TSN nodes. In some examples, the virtual TSN bridge 80 (also be referred to as virtual TSN node, TSN wireless node) may be the wireless communication network. In some examples, the virtual TSN bridge 80 may be a node implemented by the wireless communication network.

The TSN end station 45 may be configured to exchange time sensitive communication with another TSN end station through the TSN bridges 70 and the virtual TSN bridge 80. The time sensitive communication may comprise TSN streams or TSN packets or TSN flows to be exchanged between the TSN end stations. Examples of the TSN end station 45 may include, but are not limited to, robots, Automated Guided Vehicles, AGVs, with omni-wheels, excavators, or any other robotic devices. The TSN end station 45 may also be connected to the UEs associated with the virtual TSN bridge 80.

The computing device 60 is operated as an entity (also to be referred as TSN entity) of the TSN system 100. In some examples, the TSN entity may be the TSN end station. In some examples, the TSN entity may be a computing device coupled to the TSN end station.

The computing device 60 hosts a virtualized environment 50. In some examples, the virtualized environment 50 may be a cloud-computing environment. The virtualized environment 50 may comprises multiple virtualized entities/resources such as, but are not limited to, virtualized computing instances, network entities, and so on. The virtualized computing instances may include, but are not limited to, containers, virtual machines, VMs, or the like.

The virtualized computing instances may be configured to execute one or more applications. In some examples herein, the application may comprise one or more instances. The one or more instances of the application may be a copy of the application, which may be executed on one or more containers within the virtualized environment 50. As would be understood, execution of the application may refer to execution of the one or more instances of the application and associated packages (for example, libraries) on the at least one container. Examples of the applications may include for example, but are not limited to, industrial control applications, robotic applications, and so on. In some examples, the one or more applications may have different deterministic service requirements. Examples of the deterministic service requirements may include, guaranteed time synchronisation, precise end-to-end, E2E, timeliness, high reliability, low jitter, and low latency.

The network entities may be configured to be used for routing of packets from the virtualized computing instances to a physical interface on the computing device 60. The packets may be generated during execution of the one or more applications on the virtualized computing instances. The packets from the physical interface on the computing device 60 may be transmitted to any of the TSN devices, for example herein, the TSN bridge 70. Thus, the packets from the virtualized computing instances in the virtualized environment 50 have to be received at the physical interface on the computing device 60 within a time interval configured by the CNC 90 for the physical interface.

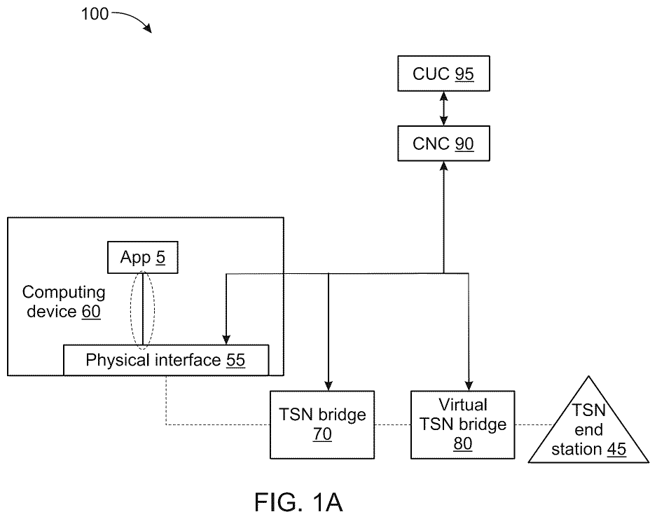

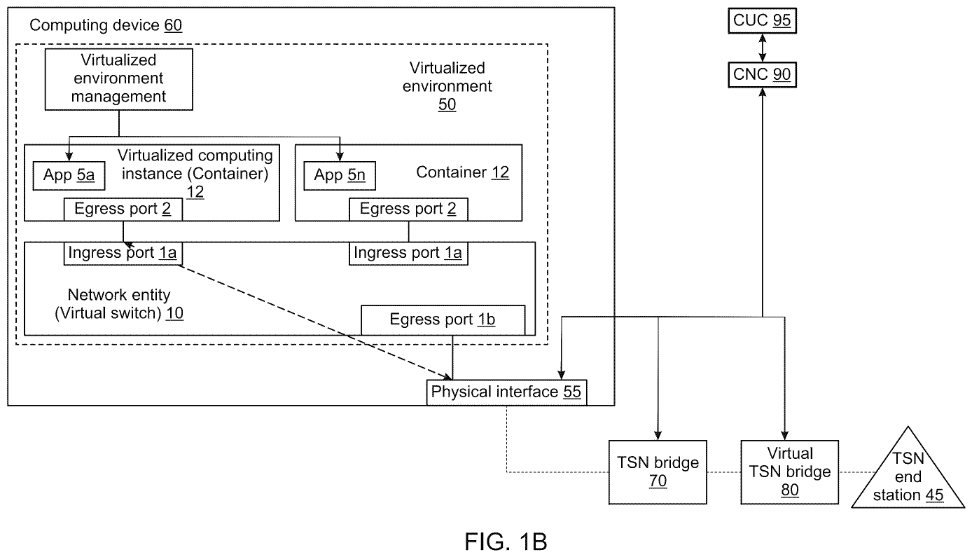

However, in some existing implementations (as described in FIG. 1B), the packets transmitted from at least virtualized computing instances in the virtualized environment 50 fail to be received at the physical interface on the computing device 60 within the time interval configured by the CNC 90 for the physical interface. Since the application is linked to a virtual interface of the at least virtualized computing instance instead of the computing device 60 and there may be a networking in the virtualized environment 50 between the application and the physical interface on the computing device 60. Further, the packets may be transmitted from the at least one virtualized computing instance to the physical interface on the computing device 60 without considering any networking details (for example, topology, latency characteristics, or the like) of entities in the virtualized environment 50, TSN traffic schedule/TSN time schedule, or the like. In addition, the CNC 90 may not able to configure the virtualized environment 50 (i.e., entities in the virtualized environment 50), as the CNC 90 is not aware of the networking details of the entities in the virtualized environment 50.

Thus, in exiting implementations, precise E2E timeliness may not be guaranteed in case of executions of the applications in the virtualized environment hosted by the computing device 60, which further results in unstable or even failed operation of the applications.

Therefore, according to some embodiments of the present disclosure, the computing device 60 implements a method within the virtualized environment 50, for enabling transmission of packets from at least one virtualized computing instance to the physical interface on the computing device 60, while guaranteeing precise E2E timeliness.

The computing device 60 identifies at least one network entity connected to the at least one virtualized computing instance in the virtualized environment 50, to be used for routing of the packets from the at least one virtualized computing instance to the physical interface on the computing device 60. The packets may be generated during execution of the at least one application on the at least one virtualized computing instance, wherein each application comprises one or more instances.

After identifying the at least one network entity, the computing device 60 determines a scheduling configuration for the at least one virtualized computing instance for transmission of the packets and for the identified at least one network entity for routing of the packets. The scheduling configuration indicates timing information and packet traffic controlling information. In some examples, the timing information may identify a time interval for the at least one virtualized computing instance/the at least one network entity for transmission/routing of the packets. In some examples, the packet controlling information may identify one or more of: a number of packets to be transmitted/routed from the at least one virtualized computing instance/the at least one network entity and a gating scheme for controlling transmission/routing of the identified number of packets according to the timing information.

The computing device 60 further causes transmission of the packets from the at least one virtualized computing instance to the physical interface through the network entity in accordance with the determined scheduling configuration. Thus, ensuring reception of the packets at the physical interface on the computing device 60 in a time interval configured by the CNC 90 for the physical interface.

Various examples for enabling transmission of packets from the at least one virtualized computing instance within the virtualized environment to the physical interface on the computing device 60 are explained in conjunction with figures in the later parts of the description.

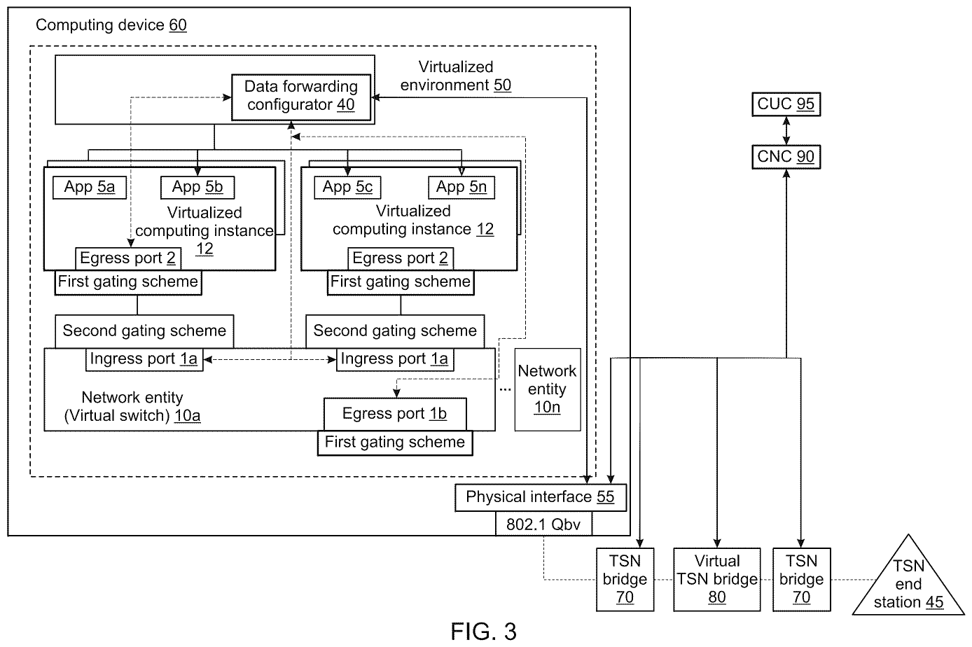

FIG. 3 discloses the computing device 60 for handling transmission of packets from the virtualised environment 50, while ensuring precise E2E timeliness.

The computing device 60 operates as an entity (for example, as a TSN end station) of the TSN system. The TSN system is integrated to the wireless communication network. The TSN system integrated to the wireless communication network may comprise the TSN bridges 70, the virtual TSN bridge 80, and the TSN end station 45.

The computing device 60 may be connected to one or more TSN bridges 70 of the TSN system. The computing device 60 may comprise a physical interface 55 for transmission of packets to the TSN bridge(s) 70. In some examples, the physical interface 55 may comprise a Network Interface Card, NIC, being connected to one or more Ethernet ports on the computing device 60. The ports of the physical interface 55 may be associated with a transmission gate for controlling transmission of the packets to the TSN bridge(s) 70. In some embodiments, as depicted in FIG. 3, the transmission gate associated with the ports of the physical interface 55 may implement a gating scheme, for example, an IEEE 802.1 Qbv time-aware scheduling based gating scheme. Such a gating scheme applies the transmission gate to be associated with a queue belonging to a Quality of Service, QoS, class and selects only queues packets/frames for transmission only when the transmission gate is open.

The computing device 60 hosts the virtualized environment 50 for execution of a plurality of applications 5a-5n, each comprising one or more instances. In some examples, the virtualized environment 50 may be a cloud-computing environment. The plurality of applications 5a-5n may be executed by utilizing generic advantages of the virtualized environment such as dynamic and elastic resource handling and scaling, flexible, adaptive application deployment management, robustness, and so on. In some examples, the plurality of applications 5a-5n may include, but are not limited to, robotic applications, industrial control applications, and so on.

The computing device 60 may also support deployment of resources in the virtualized environment 50 for execution of the applications 5a-5n. For simplicity, the virtualized environment 50 comprising resources such as a plurality of virtualized computing instances 12, and a plurality of network entities 10a-10n is depicted in FIG. 3.

The virtualized computing instance 12 may represent an addressable data compute node or an isolated user space instance. Examples of the virtualized computing instance 12 may include, but are not limited to, a container, a virtual machine, VM, a virtual private server, and so on. In some examples, the virtualized computing instance 12 may comprise virtual equivalent of hardware and software components of the computing device 60.

The virtualized computing instance 12 may be configured to execute the one or more applications/instances for generation of the packets. In some examples, the packets may be data stream, data frames, or the like. The virtualized computing instance 12 may comprise an egress port 2. In some examples, the egress port 2 may be a virtualized Ethernet port/interface. The egress port 2 may be configured for transmission of the packets from the virtualized computing instance 12 to the physical interface 55 on the computing device 60 through at least one network entity (10a-10n). For example, the egress port 2 may transmit the packets to the network entity (10a-10n), which is to be used for routing/forwarding of the packets to the physical interface 55 on the computing device 60.

The network entity (10a-10n) referred herein may include a virtual switch. The network entity (10a-10n) may comprise an ingress port 1a and an egress port 1b. In some examples, the ingress port 1a and the egress port 1b are virtualized Ethernet ports/interfaces. The ingress port 1a of the network entity (10a-10n) may be configured to receive the packets from the virtualized computing instance 12 and release the packets to the egress port 1b of the network entity (10a-10n). The egress port 1b of the network entity (10a-10n) may be configured to receive the packets from the ingress port 1a of the network entity (10a-10n) and transmit the packets to the physical interface 55 on the computing device 60.

The computing device 60 comprises a data forwarding configurator, DFC, 40 within the virtualized environment 50. The DFC 40 is adapted to configure a scheduling configuration for ingress/egress ports of at least some resources/entities (12 and 10a) in the virtualized environment for guaranteeing transmission of the packets from the virtualized environment.

For transmission of the packets, the DFC 40 identifies the at least one network entity, for example, the network entity 10a, connected to the at least one virtualized computing instance 12 within the virtualized environment 50, to be used for routing of the packets from the at least one virtualized computing instance 12 to the physical interface 55.

In some embodiments, for identifying the at least one network entity 10a, the DFC 40 obtains information related to a networking path of the virtualized environment 50 and network configurations and capabilities of the plurality of network entities 10a-10n within the virtualized environment 50. In some examples, the information related to the networking path of the virtualized environment 50 may identify one or more of: entities (for example, the virtualized computing instances 12, the network entities 10a-10n) deployed in the virtualized environment 50, and a route for transmission of the packets from at least one entity in the virtualized environment 50 to the physical interface 55. In some examples, the network configurations and capabilities of the plurality of network entities 10a-10n may indicate one or more of: a topology/deployment details of the plurality of entities 10a-10n and latency characteristics of the plurality of entities (10a-10n). In some examples, the DFC 40 may obtain/configured with the information related to the networking path of the virtualized environment 50 and the network configurations and capabilities of the plurality of network entities 10a-10n, during implementation of the DFC 40 in the virtualized environment 50.

Based on the obtained information related to the networking path of the virtualized environment 50 and the network configurations and capabilities of the plurality of network entities 10a-10n, the DFC 40 may identify the at least one network entity 10a connected to the at least one virtualized computing instance 12. The identified at least one network entity 10a is to be used for routing of the packets from the virtualized computing instance 12 to the physical interface 55.

In some embodiments, consider a scenario, where no network entity is deployed in the virtualized environment 50. In such a scenario, the DFC 40 may determine, based on the information related to the networking path of the virtualized environment 50 and the network configurations and capabilities of the plurality of network entities 10a-10n, that at least one network entity 10 is not connected to the at least one virtualized computing instance 12. Upon the determination, the DFC 40 creates the at least one network entity 10a with the ingress and egress ports (1a, 1b) for the at least one virtualized computing instance 12. The DFC 40 connects the at least one network entity 10a to the at least one virtualized computing instance 12.

Upon identifying the at least one network entity 10a, the DFC 40 determines a scheduling configuration for the at least one virtualized computing instance 12 for transmission of the packets and for the identified at least one network entity 10a for routing of the packets. Specifically, the DFC 40 may determine the scheduling configuration for the egress port 2 of the at least one virtualized computing instance 12 and the scheduling configuration for the ingress port 1a and the egress port 1b of the at least one network entity 10a. The scheduling configuration indicates timing information and packet traffic controlling information. In some examples, the timing information and the packet traffic controlling information may identify one or more of: a time interval for transmission of the packets, a number of packets to be transmitted, and a gating scheme for controlling transmission of the packets according to the time interval.

In some embodiments, for determining the scheduling configuration, the DFC 40 may obtain, from the physical interface 55, a TSN time schedule configured by the CNC 90 for the physical interface 55, and a scheduling scheme identifying scheduling of applications for execution within the virtualized environment 50. In some examples, the TSN time schedule may indicate one or more of: the gating scheme (for example, an IEEE 802.1Qbv) being implemented on at least one port of the physical interface 55 and a time interval configured for the at least one port (for example, the Ethernet port) of the physical interface 55 for reception of the packets. In some examples, the scheduling scheme may indicate one or more of: a time interval defined for execution of at least one application within the virtualized environment 50, the at least one virtualized computing instance 12 selected for execution of the at least one application (5a-5n) within the virtualized environment 50 to generate the packets and scheduling of one or more application instances of the at least one application (5a-5n) on other virtualized computing instances.

The DFC 40 may also obtain network port configurations of the egress port 2 of the at least one virtualized computing instance 12 and the ingress and egress ports (1a, 1b) of the at least one network entity 10a. In some examples, the network port configurations of the port (i.e., the egress port 2 or the ingress and egress ports (1a, 1b)) may indicate one or more of: deployment details/topology details of the port in the virtualized environment, availability of the port, and latency characteristics of the port.

The DFC 40 may also obtain the network configurations and capabilities of the at least one network entity 10a. In some examples, the network configurations and capabilities of the at least one network entity 10a may indicate one or more of: topology/deployment details of the at least one network entity 10a and latency characteristics of the at least one network entity 10a.

In some examples, the DFC 40 may obtain/configured with the network port configurations of the egress port 2 and the ingress and egress ports (1a, 1b), and the network configurations and capabilities of the at least one network entity 10a, during implementation of the DFC 40 in the virtualized environment 50.

Based on the obtained TSN time schedule, the scheduling scheme, the network port configurations and the network configurations and capabilities of the at least one network entity 10a, the DFC 40 determines the scheduling configuration for the egress port 2 of the at least one virtualized computing instance 12 and for the ingress and egress ports (1a, 1b) of the at least one network entity 10a. Thus, the scheduling configuration is determined by considering TSN configurations, characteristics of components in the virtualized environment and an effect of virtualization, which ensures transmission of packets with precise E2E timeliness. Further, traffic of packets at the at least one virtualized computing instance and the at least one network entity may be controlled in accordance with the TSN time schedule configured for the physical interface.

Thus, the scheduling configuration determined according to embodiments herein may ensure efficient internal data/packet traffic handling in the virtualized environment 50.

More specifically, for determining the scheduling configuration for the egress port 2 of the at least one virtualized computing instance 12, the DFC 40 may identify a number of packets to be transmitted at the egress port 2 of the least one virtualized computing instance 12. The DFC 40 may also determine a time interval for transmission of the identified number of packets from the egress port 2 of the at least one virtualized computing instance to the ingress port 1a of the at least one network entity 10a. In some embodiments, the DFC 40 may determine the time interval for transmission of the identified number of packets from the egress port 2 of the at least one virtualized computing instance 12 based on one or more of: the TSN time schedule, and the scheduling scheme. The DFC 40 may also select, from pre-defined gating schemes, a first gating scheme to be implemented on the egress port 2 of the at least one virtualized computing instance 12 for controlling transmission of the identified number of packets at the egress port 2 of the at least one virtualized computing instance 12 in accordance with the determined time interval. In embodiments disclosed herein, the first gating scheme may include a QoS class-aware timing information based forwarding scheme.

For determining the scheduling configuration for the ingress port 1a of the at least one network entity 10a, the DFC 40 may identify a number of packets arriving from a certain virtualized compute instance 12 to be stored in a buffer at the ingress port 1a of the at least one network entity 10a. Herein, buffering (i.e., storing the packets in the buffer) may be performed on per application (i.e., per compute instance base). The DFC 40 may also determine a time interval for releasing the packets from the buffer at the ingress port 1a to the egress port 1b of the at least one network entity 10a according to at least one pre-defined packet releasing scheme. In an example herein, the pre-defined packet releasing scheme may indicate to retain/release only newly arrived packets and to drop other packets. As would be understood, other packet releasing schemes including the above-described may be used. In some examples, the DFC 40 may determine the time interval to release the packets at the ingress port 1a of the at least one network entity 10a based on one or more of: the TSN time schedule, the schedule scheme, and the network configurations and capabilities of the at least one network entity 10a. The DFC 40 may also select, from the pre-defined gating schemes, a second gating scheme to be implemented on the ingress port 1a of the at least one network entity 10a for controlling storing and transmission of the packets at the ingress port 1a of the at least one network entity 10a in accordance with the determined time interval. In embodiments disclosed herein, the second gating scheme may include a per-stream timing information based forwarding and policing scheme. The second gating scheme may also ensure pre-defined resource (network entities, virtualized computing instances) usage between the application instances.

For determining the scheduling configuration for the egress port 1b of the at least one network entity 10a, the DFC 40 may determine a time interval for transmission of the packets from the egress port 1b of the at least one network entity 10a to the physical interface 55 on the computing device 60. In some embodiments, the DFC 40 may determine the time interval for transmission of the packets from the egress port 1b of the at least one network entity 10a based on the TSN time schedule. The DFC 40 may also select, from the pre-defined gating schemes, the first gating scheme to be implemented on the egress port 1b of the at least one network entity 10a for controlling transmission of the packets at the egress port 1b of the at least one network entity 10a in accordance with the determined time interval.

In accordance with the determined scheduling configuration, the DFC 40 causes transmission of the packets from the at least one virtualized computing instance 12 to the physical interface 55 through the at least one network entity 10a. For example, for transmitting the packets, the egress port 2 of the at least one virtualized computing instance 12 configured with the first gating scheme may identify, from the scheduling configuration, the number of packets to be transmitted and the time interval for transmission. The egress port 2 of the at least one virtualized computing instance 12 may transmit the identified number of packets to the ingress port 1a of the at least one network entity 10a in the identified time interval. The ingress port 1a of the at least one network entity 10a configured with the second gating scheme may identify, from the scheduling configuration, the number of packets to be stored and released and the time interval determined for releasing of the packets to the egress port 1b of the at least one network entity 10a. The ingress port 1a releases the identified number of packets to the egress port 1b of the at least one network entity 10a in the determined time interval. The egress port 1b of the at least one network entity 10a configured with the first gating scheme may identify, from the scheduling configuration, the time interval for transmission of the packets to the physical interface 55. The egress port 1b may transmit the packets to the physical interface 55 in accordance with the identified time interval. Thus, ensuring reception of the packets at the physical interface 55 in the time interval configured by the CNC 90 for the physical interface 55, which further guarantees precise E2E timeliness in the TSN system.

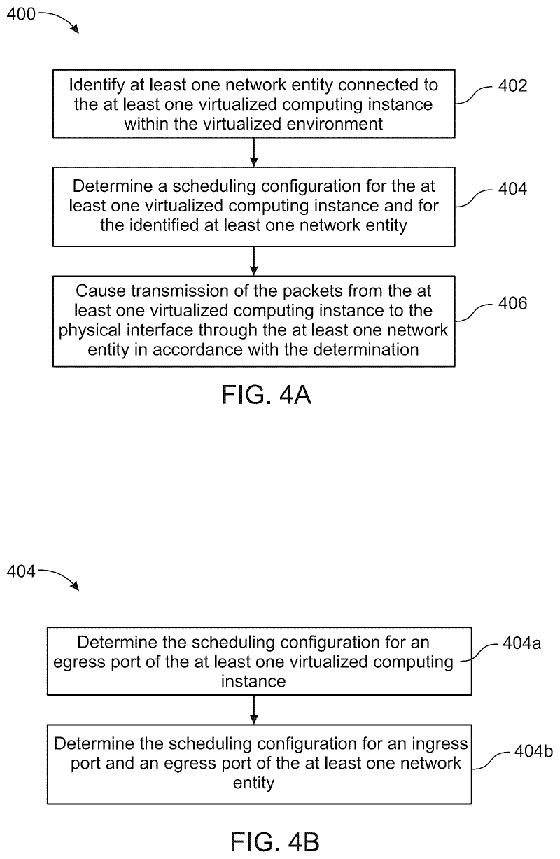

FIG. 4A is a flowchart illustrating example method steps of a method 400 performed for enabling transmission of packets from the at least one virtualized computing instance within the virtualized environment to the physical interface on the computing device. The virtualized environment is resident on the computing device. The computing device is operated as the TSN entity for the TSN system integrated to the wireless communication network. The method 400 is performed within the virtualized environment by the computing device.

At step 402, the method 400 comprises identifying the at least one network entity connected to the at least one virtualized computing instance within the virtualized environment, to be used for routing of the packets from the at least one virtualized computing instance to the physical interface. In some examples, the at least one virtualized computing instance may be a container and the at least one network entity may be a virtual switch. The packets may be generated during execution of at least one application on the at least one virtualized computing instance.

In some embodiments, the step 402 of identifying the at least one network entity may comprise obtaining information related to a networking path of the virtualized environment and network configurations and capabilities of the plurality of entities within the virtualized environment. In some examples, the information related to the networking path of the virtualized environment may identify a number of entities/entities (for example, the virtualized computing instances, the network entities, or the like) deployed in the virtualized environment, a connection between the entities in the virtualized environment, a route for transmission of packets from the virtualized environment. In some examples, the network configurations and capabilities of the plurality of entities may indicate one or more of: a topology identifying deployment details of the plurality of network entities, and latency characteristics of the plurality of network entities. Based on the obtained information related to the networking path and the network configurations and capabilities of the plurality of entities, the method may comprise identifying the at least one network entity of the plurality of network entities connected to the at least one virtualized computing instance.

Optionally, when no network entity of the plurality of network entities is deployed in the virtualized environment, the method may comprise determining, based on the obtained information related to the networking path and the network configurations and capabilities of the plurality of network entities, that the at least one network entity is not connected to the at least one virtualized computing instance. Upon determination, the method may comprise creating the at least one network entity with the ingress and egress ports for the at least one virtualized computing instance. The method may comprise connecting the at least one network entity to the at least one virtualized computing instance. Thus, ensuring connection of the at least one network entity with the at least one virtualized computing instance for routing of the packets from the at least one virtualized computing instance to the physical interface (i.e., for deploying the at least one application associated with the packets to the physical interface).

At step 404, the method 400 comprises determining a scheduling configuration indicating timing information and packet traffic controlling information for the at least one virtualized computing instance for transmission of the packets and for the identified at least one network entity for routing of the packets.

In some embodiments, the step 404 of determining the scheduling configuration may comprise determining the scheduling configuration for the egress port of the at least one virtualized computing instance and for the ingress port and the egress port of the at least one network entity.

For determining the scheduling configuration, the method may comprise obtaining, from the physical interface, a TSN time schedule configured by the CNC of the TSN system for the physical interface, and a scheduling scheme identifying scheduling of applications for execution within the virtualized environment. The method may also comprise obtaining network port configurations of the egress port of the at least one virtualized computing instance and the ingress and egress ports of the at least one network entity. The method may also comprise obtaining network configurations and capabilities of the at least one network entity.

In some examples, the TSN time schedule may indicate one or more of: a gating scheme being implemented on at least one port of the physical interface, and a time interval configured for the at least one port of the physical interface for reception of the packets.

In some examples, the scheduling scheme may indicate one or more of: a time interval defined for execution of at least one application within the virtualized environment, the at least one virtualized computing instance selected for execution of the at least one application within the virtualized environment to generate the packets, and scheduling of one or more application instances of the at least one application on other virtualized computing instances.

In some examples, the network port configurations of the port (i.e., the egress port of the at least one virtualized computing instance or the ingress and egress ports of the at least one network entity) may indicate one or more of: deployment details/topology details of the port in the virtualized environment, availability of the port, and latency characteristics of the port.

Based on the obtained TSN time schedule, the scheduling scheme, the network port configurations and the network configurations and capabilities of the at least one network entity, the method may comprise determining the scheduling configuration for the egress port of the at least one virtualized computing instance and for the ingress and egress ports of the at least one network entity. The scheduling configuration determined by considering the TSN time schedule and the virtualized environment related information may ensure reception of the packets at the physical interface in accordance with the TSN time schedule. Thus, TSN operations may not fail in an E2E manner.

Step 404 of determining the scheduling configuration for the egress port of the at least one virtualized computing instance and for the ingress and egress ports of the at least one network entity is descried in detail in conjunction with FIG. 4B.

In accordance with the determined scheduling configuration, the method 400 comprises causing transmission of the packets from the at least one virtualized computing instance to the physical interface through the at least one network entity in accordance with the determination. Thus, the packets may be transmitted from the at least one virtualized computing instance to the physical interface without any delay and without any packet loss.

FIG. 4B is a flowchart illustrating example method sub steps of step 404 performed for determining the scheduling configuration for the at least one virtualized computing instance and for the ingress and egress ports of the at least one network entity.

At step 404a, the method comprises determining the scheduling configuration for the egress port of the at least one virtualized computing instance.

In some embodiments, the step 404a of determining the scheduling configuration for the egress port of the at least one virtualized computing instance may comprise identifying a number of packets to be transmitted at the egress port of the at least one virtualized computing instance. The method may also comprise determining a time interval for transmission of the identified number of packets from the egress port of the at least one virtualized computing instance to the ingress port of the at least one network entity. The method may also comprise selecting, from pre-defined gating schemes, a first gating scheme to be implemented on the egress port of the at least one virtualized computing instance for controlling transmission of the identified number of packets at the egress port of the at least one virtualized computing instance in accordance with the determined time interval. In some examples, the first gating scheme may include a QoS class-aware timing information based forwarding scheme.

Optionally, the time interval for transmission of the identified number of packets from the egress port of the at least one virtualized computing instance is determined based on one or more of: the TSN time schedule configured by the CNC for the physical interface on the computing device and the scheduling scheme identifying scheduling of applications for execution within the virtualized environment.

At step 404b, the method comprises determining the scheduling configuration may comprise determining the scheduling configuration for the ingress port and the egress port of the at least one network entity.

In some embodiments, the step 404b of determining the scheduling configuration for the ingress port of the at least one network entity may comprise identifying a number of packets to be stored in a buffer at the ingress port of the at least one network entity. The method may also comprise determining a time interval to release the packets from the buffer at the ingress port to the egress port of the at least one network entity according to at least one pre-defined packet releasing scheme. The method may also comprise selecting, from the pre-defined gating schemes, a second gating scheme to be implemented on the ingress port of the at least one network entity for controlling storing and transmission of the packets at the ingress port of the at least one network entity in accordance with the determined time interval. In some examples, the second gating scheme may include a per-stream timing information based forwarding and policing scheme.

Optionally, the time interval to release the packets at the ingress port of the at least one network entity may be determined based on one or more of: the TSN time schedule configured by the CNC for the physical interface on the computing device, the scheduling scheme identifying scheduling of applications for execution within the virtualized environment, and the network configurations and capabilities (for example, latency characteristics) of the at least one network entity.

In some embodiments, the step 404b of determining the scheduling configuration for the egress port of the at least one network entity may comprise determining a time interval for transmission of the packets from the egress port of the at least one network entity to the physical interface on the computing device. The method may also comprise selecting, from the pre-defined gating schemes, the first gating scheme to be implemented on the egress port of the at least one network entity for controlling transmission of the packets at the egress port of the at least one network entity in accordance with the determined time interval.

Optionally, the time interval for transmission of the packets from the egress port of the at least one network entity may be determined based on the TSN time schedule.

Thus, internal data traffic routing/forwarding in the virtualized environment may be efficiently handled while guaranteeing precise E2E timeliness and without affecting any TSN operations.

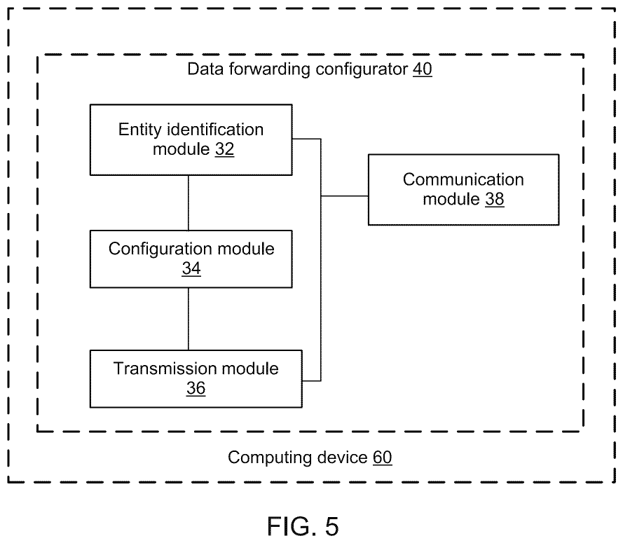

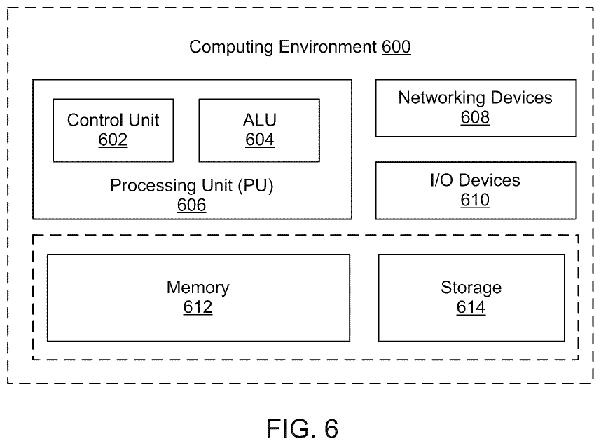

FIG. 5 is an example schematic block diagram showing functional modules of the DFC 40 being executed on the computing device 60. The computing device 60 is operated as a TSN entity for the TSN system integrated to the wireless communication network.

As depicted in FIG. 5, the DFC 40 may include one or more modules configured to cooperate with each other for enabling transmission of packets from the at least one virtualized computing instance to the at least one network entity. For example, the DFC 40 may include an entity identification module 32, a configuration module 34, a transmission module 36, and a communication module 38.

The communication module 38 may be configured to obtain, from the physical interface on the computing device 60, a TSN time schedule configured by the CNC of the TSN system for the physical interface, and a scheduling scheme identifying scheduling of applications for execution within the virtualized environment.

The entity identification module 32 may be configured to identify at least one network entity connected to the at least one virtualized computing instance within the virtualized environment, intended to be used for routing of the packets from the at least one virtualized computing instance to the physical interface.

The configuration module 34 may be configured to determine a scheduling configuration indicating timing information and packet traffic controlling information for the at least one virtualized computing instance for transmission of the packets and for the identified at least one network entity for routing of the packets. The scheduling configuration may be determined based on one or more of: the TSN time schedule, the scheduling scheme, network port configurations of the egress port of the at least one virtualized computing instance, network port configurations of the ingress and egress ports of the at least one network entity, and network configurations and capabilities of the at least one network entity.

The transmission module 36 may be configured to cause transmission of the packets from the at least one virtualized computing instance to the physical interface through the at least one network entity in accordance with the scheduling configuration.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors, DSPs, special-purpose digital logic, and the like. The processing circuitry may be configured to execute program code stored in memory, which may include one or several types of memory such as read-only memory (ROM), random-access memory, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

FIG. 6 illustrates an example computing environment 600 implementing a method and the apparatus, as described in FIG. 4A, and 3. As depicted in FIG. 6, the computing environment 600 comprises at least one data processing module 606 that is equipped with a control module 602 and an Arithmetic Logic Unit (ALU) 604, a plurality of networking devices 608 and a plurality Input output, I/O devices 610, a memory 612, a storage 614. The data processing module 606 may be responsible for implementing the method described in FIG. 4A. For example, the data processing module 606 may in some embodiments be equivalent to the DFC/CPU/processor/controller of the computing device described above in conjunction with the FIG. 3. The data processing module 606 is capable of executing software instructions stored in memory 612. The data processing module 606 receives commands from the control module 602 in order to perform its processing. Further, any logical and arithmetic operations involved in the execution of the instructions are computed with the help of the ALU 604.

The computer program is loadable into the data processing module 606, which may, for example, be comprised in an electronic apparatus (such as a computing device). When loaded into the data processing module 606, the computer program may be stored in the memory 612 associated with or comprised in the data processing module 606. According to some embodiments, the computer program may, when loaded into and run by the data processing module 606, cause execution of method steps according to, for example, any of the method illustrated in FIG. 4A or otherwise described herein.

The overall computing environment 600 may be composed of multiple homogeneous and/or heterogeneous cores, multiple CPUs of different kinds, special media and other accelerators. Further, the plurality of data processing modules 606 may be located on a single chip or over multiple chips.

The algorithm comprising of instructions and codes required for the implementation are stored in either the memory 612 or the storage 614 or both. At the time of execution, the instructions may be fetched from the corresponding memory 612 and/or storage 614, and executed by the data processing module 606.

In case of any hardware implementations various networking devices 608 or external I/O devices 610 may be connected to the computing environment to support the implementation through the networking devices 608 and the I/O devices 610.

The embodiments disclosed herein can be implemented through at least one software program running on at least one hardware device and performing network management functions to control the elements. The elements shown in FIG. 6 include blocks, which can be at least one of a hardware device, or a combination of hardware device and software module.

1. A method for enabling transmission of packets from at least one virtualized computing instance within a virtualized environment to a physical interface on a computing device, the virtualized environment being resident on the computing device, the computing device being operated as a Time-Sensitive Networking, TSN, entity for a TSN system, the TSN system being integrated to a wireless communication network the method being performed within the virtualized environment by the computing device, the method comprising:
identifying at least one network entity connected to the at least one virtualized computing instance within the virtualized environment, to be used for routing of the packets from the at least one virtualized computing instance to the physical interface;
determining a scheduling configuration indicating timing information and packet traffic controlling information for the at least one virtualized computing instance for transmission of the packets and for the identified at least one network entity for routing of the packets; and
causing transmission of the packets from the at least one virtualized computing instance to the physical interface through the at least one network entity in accordance with the determination.

2. The method according to claim 1, wherein the step of determining the scheduling configuration for the at least one virtualized computing instance and for the identified at least one network entity comprises:
determining the scheduling configuration for an egress port of the at least one virtualized computing instance; and
determining the scheduling configuration for an ingress port and an egress port of the at least one network entity.

3. The method according to claim 2, wherein the step of determining the scheduling configuration comprises:
obtaining, from the physical interface, a TSN time schedule configured by a Centralized Network Controller, CNC of the TSN system for the physical interface and a scheduling scheme identifying scheduling of applications for execution within the virtualized environment;
obtaining network port configurations of the egress port of the at least one virtualized computing instance and the ingress and egress ports of the at least one network entity;
obtaining network configurations and capabilities of at least one network entity; and
determining, based on the obtained TSN time schedule, the scheduling scheme, the network port configurations, and the network configurations and capabilities of the at least one network entity, the scheduling configuration for the egress port of the at least one virtualized computing instance and for the ingress and egress ports of the at least one network entity.

4. The method according to claim 3, wherein the TSN time schedule indicates one or more of:
a gating scheme being implemented on at least one port of the physical interface; and
a time interval configured for the at least one port of the physical interface for reception of the packets.

5. The method according to claim 3, wherein the scheduling scheme indicates one or more of:
a time interval defined for execution of at least one application within the virtualized environment;
the at least one virtualized computing instance selected for execution of the at least one application within the virtualized environment to generate the packets; and
scheduling of one or more application instances of the at least one application on other virtualized computing instances.

6. The method according to claim 3, wherein the network configurations and capabilities of the at least one network entity indicates one or more of:
a topology of the at least one network entity; and
latency characteristics of the at least one network entity.

7. The method according to claim 2, wherein the step of determining the scheduling configuration for the egress port of the at least one virtualized computing instance comprises:
identifying a number of packets to be transmitted at the egress port of the at least one virtualized computing instance;
determining a time interval for transmission of the identified number of packets from the egress port of the at least one virtualized computing instance to the ingress port of the at least one network entity; and
selecting, from pre-defined gating schemes, a first gating scheme to be implemented on the egress port of the at least one virtualized computing instance for controlling transmission of the identified number of packets at the egress port of the at least one virtualized computing instance in accordance with the determined time interval.

8. The method according to claim 7, wherein determining the time interval for transmission of the identified number of packets from the egress port of the at least one virtualized computing instance is based on one or more of:
the TSN time schedule configured by the CNC, for the physical interface on the computing device; and
the scheduling scheme identifying scheduling of applications for execution within the virtualized environment.

9. The method according to claim 2, wherein the step of determining the scheduling configuration for the ingress port of the at least one network entity comprises:
identifying a number of packets to be stored in a buffer at the ingress port of the at least one network entity;
determining a time interval for release of the packets from the buffer at the ingress port to the egress port of the at least one network entity according to at least one pre-defined packet releasing scheme; and
selecting, from the pre-defined gating schemes, a second gating scheme to be implemented on the ingress port of the at least one network entity for controlling storing and transmission of the packets at the ingress port of the at least one network entity in accordance with the determined time interval.

10. The method according to claim 9, wherein determining the time interval for release of the packets at the ingress port of the at least one network entity is based on one or more of:
the TSN time schedule configured by the CNC, for the physical interface on the computing device;
the scheduling scheme identifying scheduling of applications for execution within the virtualized environment; and
the network configurations and capabilities of the at least one network entity.

11. The method according to claim 2, wherein the step of determining the scheduling configuration for the egress port of the at least one network entity comprises:
determining a time interval for transmission of the packets from the egress port of the at least one network entity to the physical interface on the computing device; and
selecting, from the pre-defined gating schemes, the first gating scheme to be implemented on the egress port of the at least one network entity for controlling transmission of the packets at the egress port of the at least one network entity in accordance with the determined time interval.

12. The method according to claim 11, wherein determining the time interval for transmission of the packets from the egress port to the physical interface is based on the TSN time schedule configured by the CNC for the physical interface on the computing device.

13. The method according to claim 1, wherein the step of identifying the at least one network entity connected to the at least one virtualized computing instance comprises:
obtaining information related to a networking path of the virtualized environment and network configurations and capabilities of a plurality of network entities within the virtualized environment; and
identifying, based on the obtained information related to the networking path and the network configurations and capabilities of the plurality of entities, the at least one network entity of the plurality of network entities connected to the at least one virtualized computing instance.

14. The method according to claim 13, further comprising: when no network entity is implemented within the virtualized environment,
determining, based on the obtained information related to the networking path and the network configurations and capabilities of the plurality of network entities, that the at least one network entity is not connected to the at least one virtualized computing instance;
upon the determination, creating the at least one network entity with the ingress and egress ports for the at least one virtualized computing instance; and
connecting the at least one network entity to the at least one virtualized computing instance.

15. A computing device for enabling transmission of packets from at least one virtualized computing instance within a virtualized environment to a physical interface on the computing device, the virtualized environment being resident on the computing device the computing device being operated as a Time-Sensitive Networking, TSN, entity for a TSN system, the TSN system being integrated to a wireless communication network, the computing device being adapted for:
identifying at least one network entity connected to the at least one virtualized computing instance within the virtualized environment, to be used for routing of the packets from the at least one virtualized computing instance to the physical interface;
determining a scheduling configuration indicating timing information and packet traffic controlling information for the at least one virtualized computing instance for transmission of the packets and for the identified at least one network entity for routing of the packets; and
causing transmission of the packets from the at least one virtualized computing instance to the physical interface through the at least one network entity in accordance with the determination.

16. The computing device according to claim 15, wherein the computing device is adapted for determining the scheduling configuration for the at least one virtualized computing instance and for the identified at least one network entity by:
determining the scheduling configuration for an egress port of the at least one virtualized computing instance; and
determining the scheduling configuration for an ingress port and an egress port of the at least one network entity.

17. The computing device according to claim 16, wherein the computing device is adapted for determining the scheduling configuration by:
obtaining, from the physical interface, a TSN time schedule configured by a Centralized Network Controller, CNC, of the TSN system for the physical interface, and a scheduling scheme identifying scheduling of applications for execution within the virtualized environment;
obtaining network port configurations of the egress port of the at least one virtualized computing instance and the ingress and egress ports of the at least one network entity;
obtaining network configurations and capabilities of at least one network entity; and
determining, based on the obtained TSN time schedule, the scheduling scheme, the network port configurations, and the network configurations and capabilities of the at least one network entity, the scheduling configuration for the egress port of the at least one virtualized computing instance and for the ingress and egress ports of the at least one network entity.

18-26. (canceled)

27. The computing device according to claim 15, wherein the computing device is adapted for identifying the at least one network entity connected to the at least one virtualized computing instance by:
obtaining information related to a networking path of the virtualized environment and network configurations and capabilities of a plurality of network entities within the virtualized environment; and
identifying, based on the obtained information related to the networking path and the network configurations and capabilities of the plurality of entities, the at least one network entity of the plurality of network entities connected to the at least one virtualized computing instance.

28. The computing device according to claim 27, when no network entity is implemented within the virtualized environment, the computing device is adapted for:
determining, based on the obtained information related to the networking path and the network configurations and capabilities of the plurality of network entities that the at least one network entity is not connected to the at least one virtualized computing instance;
upon the determination, creating the at least one network entity with the ingress and egress ports for the at least one virtualized computing instance; and
connecting the at least one network entity to the at least one virtualized computing instance.

29. A non-transitory computer readable medium having thereon a computer program comprising program instructions, the computer program being loadable into a data processing unit and configured to cause execution of the method according to claim 1 when the computer program is run by the data processing unit.
